(19) United States
(12) Patent Application Publication
(10) Pub. No.: US 2012/0201128 A1
(43) Pub. Date: Aug. 9, 2012

(54) APPARATUS AND METHOD FOR TRANSFERRING A PACKET

(75) Inventor: Bheom Soon Joo, Daejeon (KR)

(73) Assignee: Electronics and Telecommunications Research Institute, Daejeon (KR)

(21) Appl. No.: 13/501,298

(22) PCT Filed: Oct. 12, 2010
(86) PCT No.: PCT/KR2010/006963

§ 371 Date: Apr. 11, 2012

(30) Foreign Application Priority Data
Oct. 12, 2009 (KR) 10-2009-0096847
Aug. 26, 2010 (KR) 10-2010-0082787

(51) Int. Cl. H04L 12/26; H04L 12/24; H04L 12/56

(52) U.S. Cl. 370/225; 370/389; 370/241; 370/400

(57) ABSTRACT

A packet transferring apparatus and method that may be applied to all packet systems operated on a packet transport network, to ensure the same level of reliability and availability as a circuit network. A path providing unit may acquire packet transfer path information regarding a packet transfer path from a transport network, and a subscriber interface unit may generate transport packet data by adding the packet transfer path information to packet data received from a subscriber network and may output the transport packet data. A packet switch may switch the transport packet data inputted from the subscriber interface unit, and a network interface unit may transmit the transport packet data switched by the packet switch, to the transport network along the packet transfer path.

### TECHNICAL FIELD

The present invention relates to a packet transferring apparatus and method that may be applied to all packet systems operated on a packet transport network, to ensure the same level of reliability and availability as a circuit network.

### TECHNICAL FIELD

The present invention relates to a packet transferring apparatus and method that will be applied to all packet systems operated in a packet transport network, to ensure to the same level of reliability and availability that a circuit network provides.

### BACKGROUND ART

Most of conventional packet apparatuses have no relevance to redundancy, and include a backup apparatus, in addition to a currently operated apparatus. When a problem occurs in the currently operated apparatus, the backup apparatus may be controlled to perform a function of the currently operated apparatus to provide services, until the currently operated apparatus recovers. Since even a packet apparatus with redundancy requires several seconds for switching to a redundancy after a fault is detected, a service may be inevitably disconnected. Accordingly, it is impossible to provide a real-time service, such as an audio service. Additionally, a network has insufficient reliability, since there is no function such as a network Operation, Administration, Management (OAM) function, a link protection function, a high availability function, and the like. Thus, a transport network requiring high reliability and high availability is mainly operated by a Synchronous Optical NETwork (SONET)/Synchronous Digital Hierarchy (SDH) equipment based on a Time-Division Multiplexed (TDM) line.

### BACKGROUND ART

Most of conventional packet apparatuses, contrary to the circuit apparatuses, have no relevance to redundancy, so service providers generally prepare a preliminary apparatus, in order to backup a currently operated apparatus. And when a problem occurs in the currently operated apparatus, service providers control the preliminary apparatus to backup a function of the currently operated apparatus until the currently operated apparatus recovers.

Since even a packet apparatus with redundancy, it requires several seconds for switching to a redundancy after a fault detection, a service may be inevitably disconnected and so it is not suitable to provide a real-time service, such as a voice service. Moreover, conventional packet apparatuses have no function such as a network Operation, Administration, Management (OAM) function, a link protection function, a high availability function, etc and therefore, a network has not sufficiently reliable.

Thus, a transport network requiring high reliability and high availability is mainly operated by circuit apparatuses, such as Synchronous Optical NETwork to (SONET)/Synchronous Digital Hierarchy (SDH) equipment based on a Time-Division Multiplexed (TDM).

Recently, due to an amalgamation of broadcasting and communication, new services, such as an Internet Protocol Television (IPTV) service, a User Created Content (UCC) service, and the like, are causing packet-based Internet traffic to sharply increase. Processing of the packet-based Internet traffic using the SONET/SDH equipment based on the TDM line is inefficient, and there is a limitation to a system capacity. Accordingly, technical trials has been actively conducted to introduce packet apparatuses into a transport network by supplementing functions, such as the network OAM function, the link protection function, the high availability function and the like that are absent in conventional packet apparatuses.

Recently, due to a convergence of broadcasting and telecommunications, new services, such as an Internet Protocol Television (IPTV) service, a User Created Content (UCC) service, and the like, creates packet-based Internet traffic abruptly.

Accommodating these packet-based Internet traffic by using the SONET/SDH equipment based on the TDM is inefficient and there is a limitation to a system capacity. Accordingly, technical trials has been actively conducted to introduce packet apparatuses into a transport network by supplementing functions, such as the network OAM function, the link protection function, the high availability function and the like that are absent in conventional packet apparatuses.

### DISCLOSURE OF INVENTION

### Technical Goals

An aspect of the present invention provides a packet transferring apparatus and method that may provide redundancy for a switch and a packet transfer path, and may implement a network path Operation, Administration, Management (OAM), and a link protection within 50 milliseconds, to ensure the same level of reliability and availability as a circuit network that are required in a transport network.

### DISCLOSURE OF INVENTION

### Technical Goals

An aspect of the present invention provides a packet transferring apparatus and method that may provide redundancy for a switch and a packet transfer path, and may implement a network path Operation, Administration, Management (OAM), and a link protection within 50 milliseconds, to ensure the same level of reliability and availability that a transport network requires for a existing circuit apparatus.

### Technical Solutions

According to an aspect of the present invention, there is provided a packet transferring apparatus, including: a path providing unit that acquires information regarding a packet transfer path from a transport network, and provides an optimal transfer path for packet data received from a subscriber network; a subscriber interface unit that generates a transport packet data by adding the packet transfer path information provided by the path providing unit to the packet data received from the subscriber network, and outputs the transport packet data; a packet switch that switches the transport packet data inputted from the subscriber interface unit; and a network interface unit that transmits the transport packet data switched by the packet switch, to the transport network.

The path providing unit directly acquires available packet transfer path information from the transport network, or based on a result of collecting and analyzing a variety of packet transfer path information from the transport network, selects an optimal transfer path for the packet data received from the subscriber network from among available packet transfer paths, and provides the selected transfer path. The subscriber interface unit comprises n subscriber interface modules, and wherein each of the n subscriber interface modules is connected to the subscriber network via a single physical path, and is connected to the packet switch via duplicated physical paths. Each of the n subscriber interface modules may include: a packet receiver that generates transport packet data by adding the packet transfer path information to the packet data received from the subscriber network, and generates a monitoring signals to monitor the status of the multiple physical paths; a first signal output unit that forms a first physical path having a first priority between the packet receiver and the packet switch, and outputs the transport packet data and the monitoring signal from the packet receiver to the packet switch, the transport packet data and the monitoring signal being input via the first physical path; and a second signal output unit that forms a second physical path having a second priority between the packet receiver and the packet switch, and outputs the monitoring signal from the packet receiver to the packet switch, the monitoring signal being input via the second physical path.

The packet receiver periodically generates the monitoring signal and outputs the generated monitoring signal to the first signal output unit and the second signal output unit.

The packet receiver monitors, every millisecond, a state of the first physical path and a state of the second physical path, and performs a path protection switching within 50 milliseconds when detecting a fault in the first physical path or the second physical path.

When a fault occurs in the first physical path, the packet receiver outputs the transport packet data to the second signal output unit via the second physical path.

The packet receiver constantly outputs the monitoring signal to both the first physical path and the second physical path.

The packet switch comprises a plurality of packet switching units that are connected to the subscriber interface unit and the network interface unit via the multiple physical paths.

A unit packet switching capacity of each of the plurality of packet switching units is greater than twice a total subscriber interfacing capacity of the plurality of subscriber interface modules.

The plurality of packet switching units are operated as dual active to distribute traffic.

The plurality of packet switching units respectively perform switching of a physical path having a high priority and a physical path having a low priority based on a multi-physical path operating scheme, and outputs the transport packet data.

The plurality of packet switching units provide a multi-physical path operating scheme for each board or a multi-physical path operating scheme for each port by changing only a plurality of internal switching paths.

The network interface unit comprises a plurality of network interfacing modules that are connected to the packet switch and the transport network via the multiple physical paths.

Each of the plurality of network interfacing modules may include: a switching unit that provides paths so that multiple physical paths formed between each of the network interfacing modules and the packet switch have the same priorities as multiple physical paths formed between each of the network interfacing modules and the transport network; a first signal transmitting unit that forms a third physical path between the first signal transmitting unit and the switching unit, and transmits the transport packet data and the monitoring signal to the transport network, the transport packet data and the monitoring signal being input via the third physical path; and a second signal transmitting unit that forms a fourth physical path between the second signal transmitting unit and the switching unit, and transmits the monitoring signal to the transport network, the monitoring signal being input via the fourth physical path.

When a fault occurs in the third physical path, the switching unit transmits the transport packet data to the transport network via the fourth physical path.

According to another aspect of the present invention, there is provided a packet transferring method, including: acquiring packet transfer path information regarding a packet transfer path from a transport network; generating transport packet data by adding the packet transfer path information to packet data received from a subscriber network, and outputting the transport packet data; switching the output transport packet data; and transmitting the switched transport packet data to the transport network along the packet transfer path.

The outputting comprises: generating transport packet data by adding the packet transfer path information to packet data received from a subscriber network, and generating monitoring signals to monitor the status of the multiple physical paths; outputting the transport packet data and the monitoring signal to a packet switch, the transport packet data and the monitoring signal being input via a first physical path having a first priority; and outputting the monitoring signal to the packet switch, the monitoring signal being input via a second physical path having a second priority.

The transmitting comprises: Providing the paths so that multiple physical paths formed between each of the network interfacing modules and the packet switch have the same priorities as multiple physical paths formed between each of the network interfacing modules and the transport network; transmitting the transport packet data and the monitoring signal being input via the third physical path to the transport network; and transmitting the monitoring signal being input via the fourth physical path to the transport network.

### EFFECT OF THE INVENTION

According to an embodiment of the present invention, a monitoring signal for monitoring a state of a physical path may be generated every millisecond, and a path switching may be performed within 50 milliseconds when a fault is detected, so that the same level of reliability and availability as a circuit network may be ensured in a packet network.

### EFFECT OF THE INVENTION

According to an embodiment of the present invention, a monitoring signal for monitoring a state of a physical path may be generated every millisecond, and a path protection switching may be performed within 50 milliseconds when a fault is detected, so that the same level of reliability and availability as a circuit network may be ensured in a packet network.

Additionally, according to an embodiment of the present invention, monitoring of physical paths and setting of paths may be performed in a subscriber interface unit, and physical paths may be provided with redundancy for each board or for each port in a board by a simple switching operation in a packet switch, and thus, it is possible to easily meet a user's demand for a physical path backup operating scheme, thereby improving service competitiveness.

Additionally, according to an embodiment of the present invention, monitoring of physical paths and setting of paths may be performed in a subscriber interface unit, and physical paths may be duplicated for each board or for each port in a board by a simple switching operation in a packet switch, and thus, it is possible to easily meet a user's requirement for a physical path backup operating scheme, thereby improving system competitiveness.

Furthermore, according to an embodiment of the present invention, a unit network interface unit may be configured to process a packet with a capacity corresponding to twice a packet processing capacity of a unit subscriber interface unit and thus, it is possible to transfer packet data with reliability, without reducing a system capacity even when a fault occurs in a predetermined physical path.

Furthermore, according to an embodiment of the present invention, one network interface unit may be configured to process a packet with a capacity corresponding to twice a packet processing capacity of one subscriber interface unit and thus, it is possible to transfer packet data with reliability, without reducing a system capacity even when a fault occurs in an arbitrary physical path.

Moreover, according to an embodiment of the present invention, information regarding an optimal packet transfer path may be received directly from a transport network, or an optimal packet transfer path may be selected from a variety of information regarding physical paths of a transport network and thus, it is possible to transmit received packet data to a destination via the optimal packet transfer path, regardless of a configuration of a network.

Moreover, according to an embodiment of the present invention, information regarding an optimal packet transfer path may be received directly from a transport network, or an optimal packet transfer path may be computed from a variety of information regarding physical paths of a transport network and thus, it is possible to transmit received packet data to a destination via the optimal packet transfer path, regardless of a network configuration.

### BRIEF DESCRIPTION OF DRAWINGS

FIG. 1 is a block diagram illustrating a packet transferring apparatus according to an embodiment of the present invention.

FIG. 2 is a block diagram illustrating a first subscriber matching unit.

FIG. 3 is a block diagram illustrating a packet switch.

FIG. 4 is a block diagram illustrating a first network matching unit.

FIG. 5 is a diagram illustrating a multi-physical path operating scheme for each board.

FIG. 6 is a diagram illustrating a multi-physical path operating scheme for each port.

FIG. 7 is a flowchart illustrating a packet transferring method of a packet transferring apparatus according to an embodiment of the present invention.

### BRIEF DESCRIPTION OF DRAWINGS

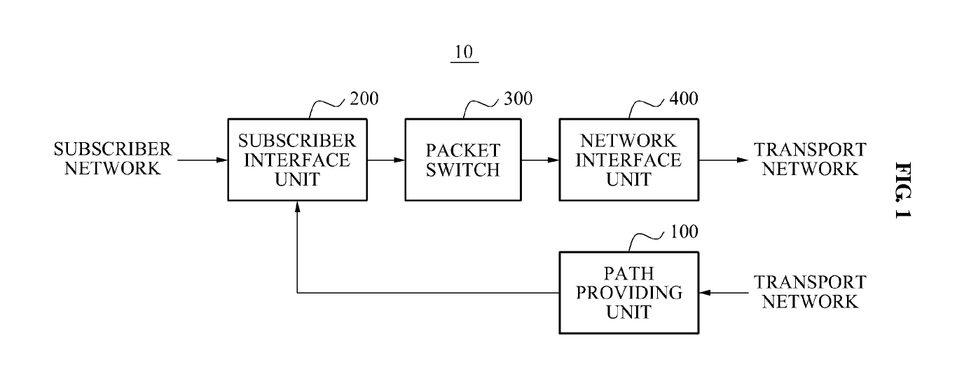

FIG. 1 is a block diagram illustrating a packet transferring apparatus according to an embodiment of the present invention.

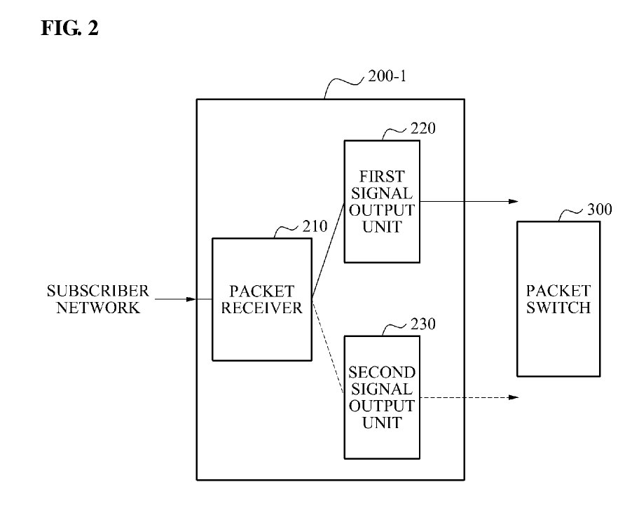

FIG. 2 is a block diagram illustrating a first subscriber interface unit.

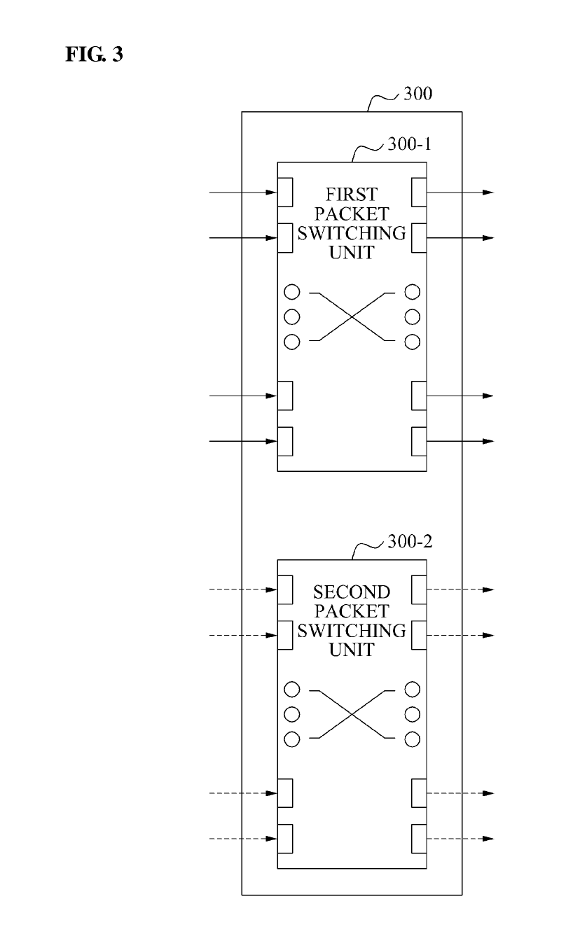

FIG. 3 is a block diagram illustrating a packet switch.

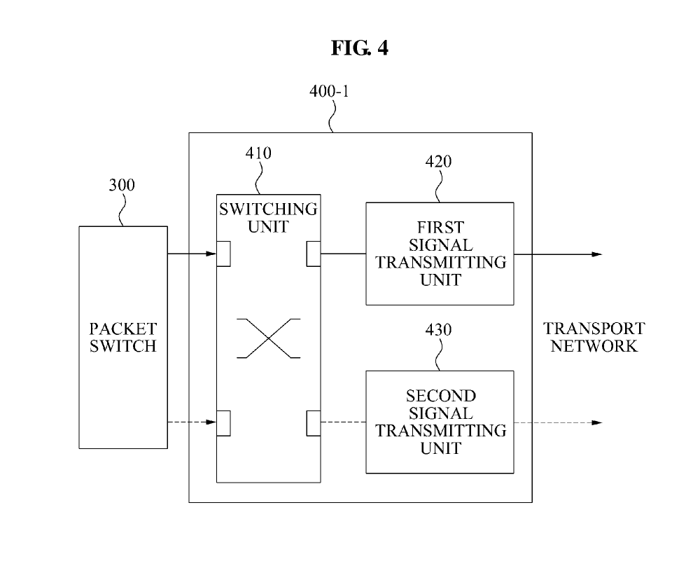

FIG. 4 is a block diagram illustrating a first network interface unit.

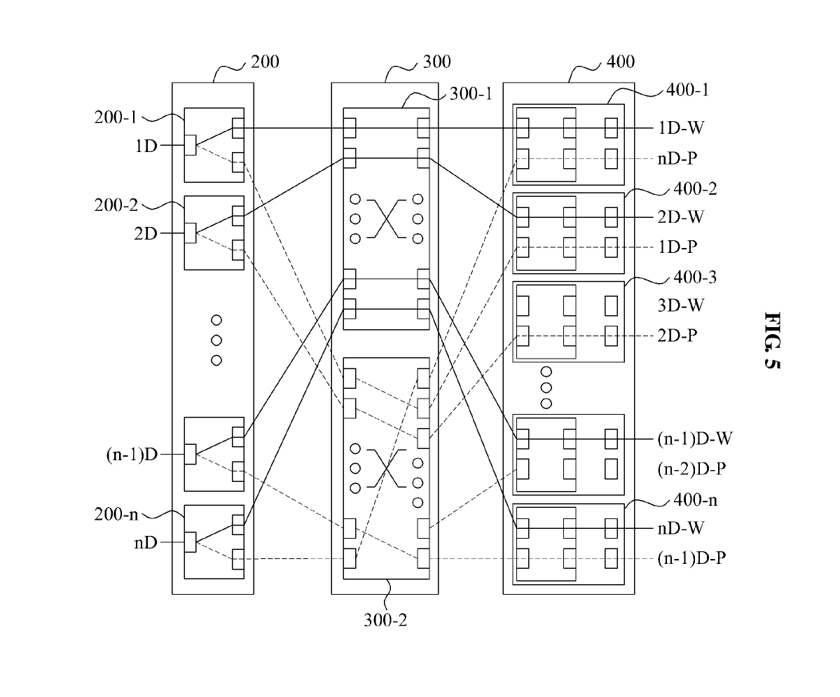

FIG. 5 is a diagram illustrating a board-level multi-physical path operating scheme.

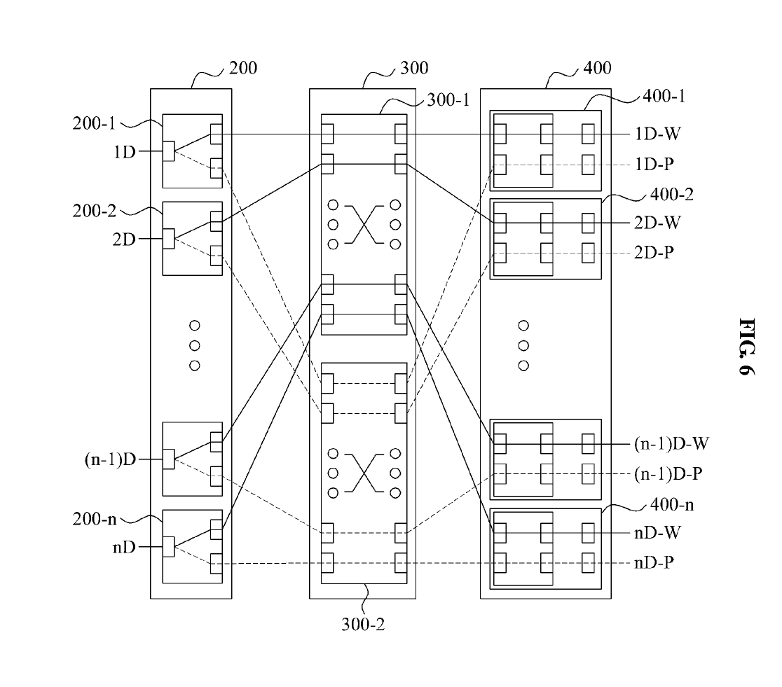

FIG. 6 is a diagram illustrating a port-level multi-physical path operating scheme.

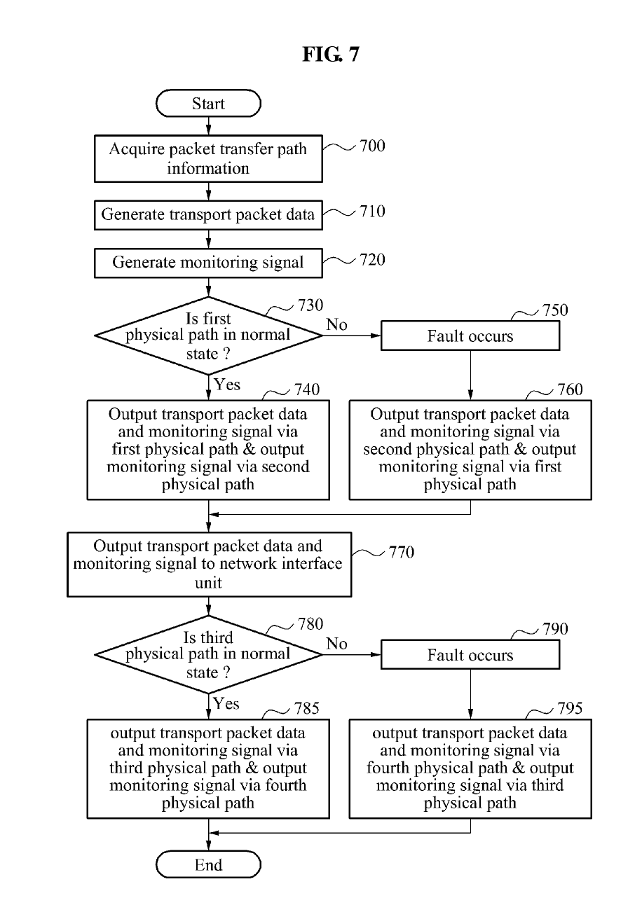

FIG. 7 is a flowchart illustrating a packet transferring method of a packet transferring apparatus according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

FIG. 1 is a block diagram illustrating a packet transferring apparatus 10 according to an embodiment of the present invention.

Referring to FIG. 1, the packet transferring apparatus 10 may include a path providing unit 100, a subscriber interface unit 200, a packet switch 300, and a network interface unit 400.

The path providing unit 100 may acquire packet transfer path information regarding a packet transfer path from a transport network, may select an optimal transfer path for packet data from among available packet transfer paths, and may provide the selected transfer path. Here, the packet data may be received from a subscriber network.

The path providing unit 100 may collect and analyze information used to determine whether a packet transfer path is available, directly from the transport network, may select a packet transfer path based on an analysis result, and may provide the selected packet transfer path. The collected information may include a bandwidth of a physical path of the transport network, fault information, information regarding whether the physical path is available, and the like. The path providing unit 100 may use, for example a Generalized Multi-Protocol Label Switching (GMPLS) protocol.

The subscriber interface unit 200 may receive packet data from the subscriber network, and may add, to the received packet data, the packet transfer path information received over the transport network from the path providing unit 100, to generate transport packet data. Additionally, the subscriber interface unit 200 may output the generated transport packet data to the packet switch 300. The subscriber interface unit 200 may include a plurality of subscriber matching units, for example, a first subscriber matching unit 200-1 through an n-th subscriber matching unit 200-n. Here, n may be a natural number, and may vary depending on the total system capacity. Each of the first subscriber matching unit 200-1 through the n-th subscriber matching unit 200-n may generate at least two physical paths, and may monitor states of the generated physical paths, that is, states of multiple physical paths. Accordingly, the first subscriber matching unit 200-1 through the n-th subscriber matching unit 200-n may be connected via a single physical path to the subscriber network, and may be connected via multiple physical paths to the packet switch 300. The first subscriber matching unit 200-1 through the n-th subscriber matching unit 200-n may be configured as shown in FIG. 2.

The packet switch 300 may have a packet switching capacity corresponding to twice the total subscriber matching capacity. The packet switch 300 may partition transport packet data and a physical path state monitoring signal that are input via a physical path having a high priority among physical paths of the first subscriber matching unit 200-1 through the n-th subscriber matching unit 200-n, and a physical path state monitoring signal that is input via a physical path having a low priority among the physical paths, into a physical path backup for each board and a physical path backup for each port, by a physical path backup operating scheme. The packet switch 300 may perform internal switching, and may output the transport packet data and the physical path state monitoring signals to the network interface unit 400.

The network interface unit 400 may switch a signal input via a physical path having a high priority from the packet switch 300, to a transport network via the physical path having the high priority, may convert the signal into a signal suitable for the transport network, and may transmit the converted signal to the transport network. Additionally, the network interface unit 400 may switch a signal input via a physical path having a low priority from the packet switch 300, to the transport network via the physical path having the low priority, may convert the signal into a signal suitable for the transport network, and may transmit the converted signal to the transport network.

The network interface unit 400 may include a plurality of network matching units, for example, a first network matching unit 400-1 through an n-th network matching unit 400-n. The first network matching unit 400-1 through an n-th network matching unit 400-n may be configured as shown in FIG. 4.

FIG. 2 is a block diagram illustrating the first subscriber matching unit 200-1.

Referring to FIG. 2, the first subscriber matching unit 200-1 may include a packet receiver 210, a first signal output unit 220, and a second signal output unit 230.

The packet receiver 210 may generate transport packet data by adding the packet transfer path information to packet data received from the subscriber network, and may generate at least two physical paths, namely, multiple physical paths. The packet receiver 210 may add the packet transfer path information to a header of the packet data, so that the transport packet data may be generated. Accordingly, the packet transfer path information may be included in the transport packet data, and may be transmitted.

The packet receiver 210 may set a priority for each of the generated multiple physical paths. The multiple physical paths indicate a plurality of physical paths for transmitting packet data to the transport network.

Hereinafter, a first physical path and a second physical path are described as examples of multiple physical paths. The packet receiver 210 may give a high priority (for example, a first priority) to the first physical path, and may give a low priority (for example, a second priority) to the second physical path. The first physical path may be formed between the packet receiver 210 and the first signal output unit 220, and the second physical path may be formed between the packet receiver 210 and the second signal output unit 230.

The packet receiver 210 may generate a monitoring signal used to monitor a state of the first physical path and a state of the second physical path. The packet receiver 210 may periodically generate a monitoring signal and output the generated monitoring signal to the first signal output unit 220 and the second signal output unit 230. The monitoring signal may be transmitted to an end of the first physical path and an end of the second physical path.

When the first physical path and the second physical path are in the normal state, the packet receiver 210 may output the transport packet data and monitoring signal to the first signal output unit 220 via the first physical path having the first priority. Additionally, the packet receiver 210 may output the monitoring signal to the second signal output unit 230 via the second physical path having the second priority.

The first signal output unit 220 may form the first physical path, together with the packet receiver 210, and may output, to the packet switch 300, the transport packet data and monitoring signal that are input via the first physical path.

The second signal output unit 230 may form the second physical path, together with the packet receiver 210, and may output, to the packet switch 300, the monitoring signal input via the second physical path.

When a fault is determined to occur in the first physical path in response to an acknowledge (ACK) of the monitoring signal, the packet receiver 210 may perform path switching. Accordingly, the packet receiver 210 may output the transport packet data and monitoring signal via the second physical path, and may output the monitoring signal via the first physical path. Here, a controller (not shown) may determine whether a fault occurs in the first physical path.

The above-described packet receiver 210 may generate a monitoring signal, for example, every millisecond, and may monitor the states of the physical paths. Accordingly, the packet receiver 210 may perform the path switching, every millisecond, with respect to the second physical path having the second priority.

The packet switch 300 may output the transport packet data input from the subscriber interface unit 200 to the network interface unit 400. The packet switch 300 may include a first packet switching unit 300-1, and a second packet switching unit 300-2. The first packet switching unit 300-1 and the second packet switching unit 300-2 may be connected via multiple physical paths to the subscriber interface unit 200 and the network interface unit 400. The first packet switching unit 300-1 and the second packet switching unit 300-2 may be configured as shown in FIG. 3. The packet switch 300 includes only the first packet switching unit 300-1 and the second packet switching unit 300-2 as shown in FIG. 3, but there is no limitation to a number of packet switching units in the packet switch 300.

FIG. 3 is a block diagram illustrating the packet switch 300.

Referring to FIG. 3, the packet switch 300 includes the first packet switching unit 300-1 and the second packet switching unit 300-2. The first packet switching unit 300-1 may receive transport packet data and monitoring signals from the first subscriber matching unit 200-1 through the n-th subscriber matching unit 200-n. The second packet switching unit 300-2 may receive monitoring signals from the first subscriber matching unit 200-1 through the n-th subscriber matching unit 200-n. In other words, the first packet switching unit 300-1 and the second packet switching unit 300-2 may be operated as a dual active to distribute traffic.

Additionally, the first packet switching unit 300-1 and the second packet switching unit 300-2 may respectively include a plurality of switching paths by a multi- physical path operating scheme, and may output transport packet data based on the priority of the switching paths. In other words, the first packet switching unit 300-1 and the second packet switching unit 300-2 may respectively switch the transport packet data and monitoring signal that are input via the first physical path, and the monitoring signal input via the second physical path, based on the physical path duplication operating scheme. For example, the first packet switching unit 300-1 may output transport packet data input from the first subscriber matching unit 200-1, via a third physical path of the network interface unit 400. Here, the third physical path will be described below with reference to FIG. 4.

A packet switching capacity of each of first packet switching unit 300-1 and second packet switching unit 300-2 may be greater than the total subscriber matching capacity of the first subscriber matching unit 200-1 through the n-th subscriber matching unit 200-n. For example, the first packet switching unit 300-1 may have a packet switching capacity corresponding to twice the subscriber matching capacity of the first subscriber matching unit 200-1.

The first packet switching unit 300-1 and the second packet switching unit 300-2 may switch only a plurality of internal switching paths, and may provide a multi-physical path operating scheme for each board, or a multi-physical path operating scheme for each port. The multi-physical path operating scheme for each board, and the multi-physical path operating scheme for each port will be respectively described below with reference to FIGS. 5 and 6.

Referring back to FIG. 1, the network interface unit 400 may transmit the transport packet data and monitoring signal input from the packet switch 300, along the packet transfer path to the transport network. The network interface unit 400 may include a plurality of network matching units, for example, a first network matching unit 400-1 through an n-th network matching unit 400-n.

The first network matching unit 400-1 through the n-th network matching unit 400-n may be connected via multiple physical paths to the packet switch 300 and the transport network. Specifically, the first network matching unit 400-1 through the n-th network matching unit 400-n may be multiplexed and connected to the packet switch 300 by a plurality of physical paths having different priorities. Additionally, the first network matching unit 400-1 through the n-th network matching unit 400-n may be respectively connected to the transport network by the plurality of physical paths having different priorities. The first network matching unit 400-1 through the n-th network matching unit 400-n may be configured as shown in FIG. 4.

FIG. 4 is a block diagram illustrating the first network matching unit 400-1.

Referring to FIG. 4, the first network matching unit 400-1 includes a switching unit 410, a first signal transmitting unit 420, and a second signal transmitting unit 430.

The switching unit 410 may provide paths so that multiple physical paths formed between the first network matching unit 400-1 and the packet switch 300 may have the same priorities as multiple physical paths formed between the first network matching unit 400-1 and the transport network.

In other words, the switching unit 410 may provide a path through which transport packet data and a monitoring signal input via a physical path having a high priority (for example, a first physical path and a first switching path) from the packet switch 300 are output to the first signal transmitting unit 420 that provides a physical path having a high priority (for example, a third physical path). Additionally, the switching unit 410 may provide a path through which a monitoring signal input via a physical path having a low priority (for example, a second physical path) from the packet switch 300 is output to the second signal transmitting unit 430 that provides a physical path having a low priority (for example, a fourth physical path).

When the third physical path and fourth physical path that will be described below are in the normal state, the switching unit 410 may output the transport packet data and monitoring signal via the third physical path having a high priority to the first signal transmitting unit 420. The switching unit 410 may also output the monitoring signal via the fourth physical path having a low priority to the second signal transmitting unit 430.

When a fault occurs in the third physical path, the switching unit 410 may output the transport packet data and monitoring signal to the second signal transmitting unit 430 via the fourth physical path having a lower priority than the third physical path.

When the multiple physical paths include the first physical path and the second physical path, the switching unit 410 may have a structure of 2 x 2 packet switch.

The first signal transmitting unit 420 may form the third physical path, together with the switching unit 410. The first signal transmitting unit 420 may convert the transport packet data and monitoring signal input via the third physical path into a signal suitable for the transport network, and may transmit the converted signal to the transport network.

The second signal transmitting unit 430 may form the fourth physical path, together with the switching unit 410, may convert the monitoring signal input via the fourth physical path into a signal suitable for the transport network, and may transmit the converted signal to the transport network. The fourth physical path may have a lower priority than the third physical path. For example, when an optical signal is suitable for the transport network, the first signal transmitting unit 420 and the second signal transmitting unit 430 may convert the transport packet data and monitoring signal into an optical signal, and may transmit the converted optical signal to the transport network.

When the third physical path having a higher priority than the fourth physical path is in the normal state, the first signal transmitting unit 420 may transmit, to the transport network, transport packet data corresponding to the subscriber network matching capacity of the first subscriber matching unit 200-1. When a fault occurs in the third physical path, another network matching unit, for example the second network matching unit 400-2, may transmit, to the transport network, transport packet data corresponding to twice the subscriber network matching capacity of the first subscriber matching unit 200-1.

Additionally, as shown in FIG. 5 that will be described below, 1D-W, 2D-W, 3D-W, . . . , and nD-W may indicate physical paths having higher priorities, and may include the third physical path. When faults occur in two physical paths 1D-W and 2D-W among the physical paths, two network matching units among a third network matching unit 400-3 through the n-th network matching unit 400-n may transmit, to the transport network, transport packet data of the first subscriber matching unit 200-1 and second subscriber matching unit 200-2, so that transport packet data corresponding to twice the unit subscriber network matching capacity may be transmitted to the transport network.

FIG. 5 is a diagram illustrating a multi-physical path operating scheme for each board.

Referring to FIG. 5, 1D, 2D, . . . , and nD indicate transport packet data that is input from the subscriber network, and 1D-W, 2D-W, 3D-W, . . . , and nD-W indicate physical paths that have higher priorities and that enable transport packet data and monitoring signals to be transmitted. For example, 1D-W indicates a path through which first transport packet data 1D input from the first subscriber matching unit 200-1, and a monitoring signal generated in the first subscriber matching unit 200-1 are transmitted. 1D-P, 2D-P, . . . , and (n-1)D-P indicate physical paths that have lower priorities and that enable monitoring signals to be transmitted. For example, 1D-P indicates a path through which a monitoring signal generated in the first subscriber matching unit 200-1 is transmitted.

Boards of FIG. 5 respectively indicate the first network matching unit 400-1 through the n-th network matching unit 400-n. When dual physical paths are operated for each board, transport packet data and a monitoring signal output from a same subscriber matching unit may be input to different network matching units. In FIG. 5, transport packet data and a monitoring signal output from the first subscriber matching unit 200-1 may be input to the first network matching unit 400-1 via the path 1D-W, and a monitoring signal may be input to the second network matching unit 400-2 via the path 1D-P.

FIG. 6 is a diagram illustrating a multi-physical path operating scheme for each port.

1D through nD, 1D-W through nD-W, and 1D-P through nD-P of FIG. 6 may indicate the same elements as described above with reference to FIG. 5. When backup of physical paths are operated for each port, transport packet data and a monitoring signal output from a same subscriber matching unit may be input to different ports of a same network matching unit.

In FIG. 6, transport packet data and a monitoring signal output from the first subscriber matching unit 200-1 may be input to the first network matching unit 400-1 via the path 1D-W, and a monitoring signal may be input to the first network matching unit 400-1 via the path 1D-P.

FIG. 7 is a flowchart illustrating a packet transferring method of a packet transferring apparatus according to an embodiment of the present invention.

The packet transferring method of FIG. 7 may be performed by the packet transferring apparatus 10 described above with reference to FIGS. 1 through 6.

In operation 700, a path providing unit may acquire packet transfer path information regarding a packet transfer path from a transport network, may select an optimal transfer path for packet data from among available packet transfer paths, and may provide the selected transfer path. Here, the packet data may be received from a subscriber network.

In operation 710, a subscriber interface unit may receive packet data from the subscriber network, and may generate transport packet data by adding the packet transfer path information to the received packet data.

In operation 720, the subscriber interface unit may generate a monitoring signal used to monitor a state of a first physical path having a first priority, and may generate a monitoring signal used to monitor a state of a second physical path having a second priority.

When the first physical path is in the normal state in operation 730, the subscriber interface unit may output the transport packet data and monitoring signal via the first physical path to a packet switch, and may output the monitoring signal via the second physical path to the packet switch in operation 740.

Conversely, when a fault occurs in the first physical path in operation 750, the subscriber interface unit may output the transport packet data and monitoring signal via the second physical path to the packet switch, and may output the monitoring signal via the first physical path to the packet switch in operation 760.

In operation 770, the packet switch may output, to a network interface unit, the transport packet data and monitoring signals that are input from the subscriber interface unit in operation 740 or 760.

When a third physical path is in the normal state in operation 780, the network interface unit may output, via the third physical path to the transport network, the transport packet data and monitoring signal input via the first physical path, and may output, via a fourth physical path to the transport network, the monitoring signal input via the second physical path in operation 785.

Conversely, when a fault occurs in the third physical path in operation 790, the network interface unit may output, via the fourth physical path to the transport network, the transport packet data and monitoring signal input via the first physical path, and may output, via the third physical path to the transport network, the monitoring signal input via the second physical path in operation 795.

The transport network described above with reference to FIG. 1 may be used to provide a packet transfer path, and may not be connected directly to a subscriber. The transport network may have an extremely wide bandwidth, so that a great amount of data may be transmitted via the transport network. The transport network may include, for example a core network, and a metro network, but is not limited thereto.

Additionally, the above-described packet transferring apparatus 10 may be located between two transport networks, or between a subscriber network and a transport network.

The packet transfer path information provided by the transport network to the packet transferring apparatus 10 may refer to information regarding a path or a link through which a packet is actually transferred. The packet transfer path information may include, for example, a resource occupancy status of equipments located within a transport network, state information of links where packets are transferred within a transport network, a shortest path, an optimal path, a best path, a next best path, and the like.

Additionally, the packet transferring apparatus 10 may further include a controller (not shown). The controller may control the path providing unit 100 to select and provide the packet transfer path information, and may control the subscriber interface unit 200 to generate transport packet data and monitoring signals, to generate multiple physical paths, and to set the priority for each of the multiple physical paths. The controller may also control the packet switch 300 to appropriately perform a switching operation for each physical path, and may control the network interface unit 400 to transmit the transport packet data and monitoring signals to the transport network along the multiple physical paths.

Furthermore, according to an embodiment of the present invention, a working path and a guarded path may be adaptively provided. The working path may have a high priority, and may be used to transfer transport packet data along with a monitoring signal for monitoring a state of a path. The guarded path may be used to transfer transport packet data when a fault occurs in the working path, and may be referred to as a standby path. Here, it is possible to efficiently and adaptively transfer transport packet data using the two paths. Thus, it is possible to provide functions, such as a network Operation, Administration, Management (OAM) function, a link protection function, a high availability function and the like, thereby ensuring a reliability of a network.

The methods according to the above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A packet transferring apparatus, comprising:
a path providing unit that acquires information regarding a packet transfer path from a transport network, and provides an optimal transfer path for packet data received from a subscriber network;
a subscriber interface unit that generates a transport packet data by adding the packet transfer path information provided by the path providing unit to the packet data received from the subscriber network, and outputs the transport packet data;
a packet switch that switches the transport packet data inputted from the subscriber interface unit; and
a network interface unit that transmits the transport packet data switched by the packet switch, to the transport network.

2. The packet transferring apparatus of claim 1, wherein the path providing unit directly acquires available packet transfer path information from the transport network, or based on a result of collecting and analyzing a variety of packet transfer path information from the transport network, selects an optimal transfer path for the packet data received from the subscriber network from among available packet transfer paths, and provides the selected transfer path.

3. The packet transferring apparatus of claim 1, wherein the subscriber interface unit comprises n subscriber interface modules, and
wherein each of the n subscriber interface modules is connected to the subscriber network via a single physical path, and is connected to the packet switch via duplicated physical paths.

4. The packet transferring apparatus of claim 3, wherein each of the n subscriber interface modules comprises:
a packet receiver that generates transport packet data by adding the packet transfer path information to the packet data received from the subscriber network, and generates a monitoring signals to monitor the status of the multiple physical paths;
a first signal output unit that forms a first physical path having a first priority between the packet receiver and the packet switch, and outputs the transport packet data and the monitoring signal from the packet receiver to the packet switch, the transport packet data and the monitoring signal being input via the first physical path; and
a second signal output unit that forms a second physical path having a second priority between the packet receiver and the packet switch, and outputs the monitoring signal from the packet receiver to the packet switch, the monitoring signal being input via the second physical path.

5. The packet transferring apparatus of claim 4, wherein the packet receiver periodically generates the monitoring signal and outputs the generated monitoring signal to the first signal output unit and the second signal output unit.

6. The packet transferring apparatus of claim 5, wherein the packet receiver monitors, every millisecond, a state of the first physical path and a state of the second physical path, and performs a path protection switching within 50 milliseconds when detecting a fault in the first physical path or the second physical path.

7. The packet transferring apparatus of claim 4, wherein, when a fault occurs in the first physical path, the packet receiver outputs the transport packet data to the second signal output unit via the second physical path.

8. The packet transferring apparatus of claim 4, wherein the packet receiver constantly outputs the monitoring signal to both the first physical path and the second physical path.

9. The packet transferring apparatus of claim 1, wherein the packet switch comprises a plurality of packet switching units that are connected to the subscriber interface unit and the network interface unit via the multiple physical paths.

10. The packet transferring apparatus of claim 9, wherein a unit packet switching capacity of each of the plurality of packet switching units is greater than twice a total subscriber interfacing capacity of the plurality of subscriber interface modules.

11. The packet transferring apparatus of claim 9, wherein the plurality of packet switching units are operated as dual active to distribute traffic.

12. The packet transferring apparatus of claim 9, wherein the plurality of packet switching units respectively perform switching of a physical path having a high priority and a physical path having a low priority based on a multi-physical path operating scheme, and outputs the transport packet data.

13. The packet transferring apparatus of claim 10, wherein the plurality of packet switching units provide a multi-physical path operating scheme for each board or a multi-physical path operating scheme for each port by changing only a plurality of internal switching paths.

14. The packet transferring apparatus of claim 1, wherein the network interface unit comprises a plurality of network interfacing modules that are connected to the packet switch and the transport network via the multiple physical paths.

15. The packet transferring apparatus of claim 14, wherein each of the plurality of network interfacing modules comprises:
a switching unit that provides paths so that multiple physical paths formed between each of the network interfacing modules and the packet switch have the same priorities as multiple physical paths formed between each of the network interfacing modules and the transport network;
a first signal transmitting unit that forms a third physical path between the first signal transmitting unit and the switching unit, and transmits the transport packet data and the monitoring signal to the transport network, the transport packet data and the monitoring signal being input via the third physical path; and
a second signal transmitting unit that forms a fourth physical path between the second signal transmitting unit and the switching unit, and transmits the monitoring signal to the transport network, the monitoring signal being input via the fourth physical path.

16. The packet transferring apparatus of claim 13, wherein, when a fault occurs in the third physical path, the switching unit transmits the transport packet data to the transport network via the fourth physical path.

17. A packet transferring method, comprising:
acquiring packet transfer path information regarding a packet transfer path from a transport network;
outputting transport packet data by adding the packet transfer path information to packet data received from a subscriber network, and outputting the transport packet data;
switching the output transport packet data; and
transmitting the switched transport packet data to the transport network along the packet transfer path.

18. The packet transferring method of claim 17, wherein the outputting comprises:
generating transport packet data by adding the packet transfer path information to packet data received from a subscriber network, and generating monitoring signals to monitor the status of the multiple physical paths;
outputting the transport packet data and the monitoring signal to a packet switch, the transport packet data and the monitoring signal being input via a first physical path having a first priority; and
outputting the monitoring signal to the packet switch, the monitoring signal being input via a second physical path having a second priority.

19. The packet transferring method of claim 18, wherein, when a fault occurs in the first physical path, the transport packet data is outputted via the second physical path.

20. The packet transferring method of claim 17, wherein the transmitting comprises:
Providing the paths so that multiple physical paths formed between each of the network interfacing modules and the packet switch have the same priorities as multiple physical paths formed between each of the network interfacing modules and the transport network;
transmitting the transport packet data and the monitoring signal being input via the third physical path to the transport network; and
transmitting the monitoring signal being input via the fourth physical path to the transport network.
